(19) United States
(12) Patent Application Publication
(10) Pub. No.: US 2012/0052222 A1
(43) Pub. Date: Mar. 1, 2012

(54) LIGHTWEIGHT BALLISTIC PROTECTION MATERIALS,

(76) Inventor: Robert R. Gagne, Bay St. Louis, MS (US)

(21) Appl. No.: 12/672,932

(22) PCT Filed: Aug. 11, 2008
(86) PCT No.: PCT/US08/72810

§ 371 Date: Nov. 11, 2011

Related U.S. Application Data
(60) Provisional application No. 60/964,280, filed on Aug. 10, 2007.

(51) Int. Cl. F41H 1/02; B32B 27/18; F41H 1/04; C08L 81/06; C08L 65/02; C08K 3/38; C08K 3/22; C08K 3/34; C08K 13/02; F41H 7/02; B64D 7/00; F41H 5/24; F41H 5/08; F41H 5/00; B63G 9/00; B29C 69/02; B29C 43/00; B29C 59/02; B29C 45/00; B29C 53/00; B29C 51/00; B29C 47/00; B32B 18/00

(52) U.S. Cl. 428/34.5; 428/64.1; 428/121; 428/174; 2/2.5; 524/500; 524/1; 524/404; 524/430; 524/443; 524/262; 89/36.08; 89/36.11; 89/36.04; 89/36.05; 89/36.01; 89/36.12; 264/241; 264/319; 264/293; 264/328.18; 977/779; 89/917; 89/920; 89/921; 89/930

(57) ABSTRACT

A class of lightweight ballistic protection material and methods of forming such materials are disclosed. The material comprises a composite of polymeric material comprising high modulus resins and ceramic materials. The composite materials offer the advantage of being relatively easy to fabricate and lower in cost than competing materials. Body armor, blast protection panels and other articles comprising the new ballistic protection materials are also disclosed.

### FIELD OF THE INVENTION

The current invention is directed to a lightweight ballistic protection material, and more specifically to a lightweight ballistic protection material incorporating a high modulus polymeric material.

### BACKGROUND OF THE INVENTION

Very hard materials have increasingly found utility in ballistic protection as armor materials. Such hard materials often include metals and ceramics. Such hard materials function, in part, by helping to break-up a projectile into fragments, see for example, Normandia et al. in Amptiac Quarterly (Vol 8, No 4, 2004 p 21); Viechniki et al in “Development and Current Status of Armor Ceramics (Cer. Bul. 70, [6], 1991; Sternberg J. in “Material Properties Determining the Resistance of Ceramics to High Velocity Penetration (J. Appl. Physics 65, [9], 1989; and Lundberg et al. in “Impact of Metallic Projectiles on Ceramic Targets; Transition Between Interface Defeat and Penetration, (Int. J. Impact Eng, 19, pp 1-13, 1997).

Although metals are theoretically well suited for ballistic protection applications because they are generally dense and have high impact resistance properties, metals are also heavy and thus of limited usefulness for weight sensitive applications. In contrast, certain ceramic materials, such as boron carbide, aluminas and silicas, have impact resistance properties on par with metals, but are lower in density and thus can serve as relatively lightweight ballistic protection materials. These lightweight ballistic protection materials have special utility in weight sensitive applications, such as for personal body armor and vehicle armor. However, lightweight ceramic ballistic protection materials can be difficult to fabricate and thus can be of high cost. For example, fabricating ceramic plates can include fabrication of a precursor plate (green body) followed by a separate high temperature curing step. The high cost associated with these manufacturing steps can limit their utility.

Because of the inherent limitations of these two most common hard armor materials, they are typically used in conjunction with other types of armor materials. For example, a hard material can be backed by a ballistic fiber material, such as woven polyaramid (e.g., Kevlar®) or polyethylene (e.g., Spectra®) fabric. In these composites the configuration of the hard material serves to break-up the projectile and absorb some of the projectile's impact energy, while the fabric backing further absorbs energy and stops the fragments.

Composites of ceramic powders and polymers can be fabricated easily and at relatively low cost by a number of methods. Such composites are known in the art for various applications. Composites with high (>90%) ceramic loading are used for countertop materials, for example, Zodiaq® (DuPont) is used in the manufacture of countertops as disclosed in U.S. Pat. No. 6,387,985, which is incorporated herein by reference. U.S. Pat. No. 6,525,125 (Materia Inc.) discloses a composite of ceramic powders and polydicyclopentadiene, which the authors claim has a number of uses including the fabrication of sporting equipment, industrial and scratch resistant coatings, and ballistics and blast containment materials. U.S. Pat. No. 4,969,386 (U.S. DOE) discloses an armor system comprising a series of constraint cells filled with a ceramic dispersed in a polymer matrix. The ceramic powder in the '386 patent is said to abrade projectiles hitting the device.

These prior composites invariably use low modulus polymers as a matrix. Typical matrix materials include polyacrylates, polycyclopentadiene, and epoxy resins, ('985, '125, and '386 patents respectively). All of these materials have low elastic moduli, typical of most polymers. Although the low modulus of these polymer materials compensates for the high coefficient of thermal expansion (CTE) of the polymer matrix, and allows the polymer to yield without cracking as swings in temperature effect the ceramic Row CTE) and polymers (high CTE) differently, the low modulus also reduces the hardness and stiffness of the overall composite reducing the effectiveness of these materials as armor.

Despite the inherent limitations of these materials, experts in the field have been forced to make this tradeoff because of cost, perceived processability issues with using higher modulus materials, and conventional wisdom concerning the role polymers play in traditional polymer/ceramic composites. First, as a result of both inherent low glass transition temperatures and the market pressures, low modulus polymers have very good processability/cost profiles. Second, from the standpoint of polymeric architecture, polymeric low modulus is positively correlated with low glass transition and melting point temperatures. These properties, in turn are positively correlated with low viscosity and hence good processability. In addition, traditionally low modulus polymers were used in conjunction with ceramics in an attempt to mitigate some of the inherent brittleness of the ceramic. In short, the ultimate goal for armor manufacturers is to create a composite that would combine the very high hardness of ceramics with the improved ductility of the low modulus polymeric materials, thereby possessing the best properties of both material classes. As a result of these considerations the field of lightweight ballistic protection has been dominated by materials that incorporate these low modulus polymers, despite the inherent limitations that result in the protective capabilities of the armors using these materials.

Accordingly, it would be desirable to have lightweight ballistic protection materials that are easy to fabricate into final armor components, at reasonable cost, yet still offer ballistic protection properties on par with heavier armor materials. Such materials would find ready use in a number of applications, including personal armor (military, law enforcement, civilian); vehicle armor (especially cars and light transport vehicles); aircraft armor (especially rotary wing aircraft); blast containment (e.g., shipping containers) and other applications that are weight sensitive.

### SUMMARY OF THE INVENTION

The current invention is directed to a ballistic protection material composition comprising one or more type of ceramic powders or particles mixed with one or more type of polymeric materials, wherein at least one of the polymeric materials comprises a high hardness or high stiffness polymer.

In one embodiment at least one of the polymeric materials is selected from the group consisting of rigid-rod polymers, semi-rigid-rod polymers, polyimides, polyetherimides, polyimideamides, polysulfones, epoxy resins, bismaleimide resins, bis-benzocyclobutene resins, phthalonitrile resins, polyaryletherketones, polyetherketones, liquid crystal polymers, oligomeric cyclic polyester precursors, polybenzbisoxazoles, polybenzbisthiazoles, polybenzbisimidazoles, acetylene endcapped thermosetting resins, PrimoSpire™ polymers, polysulfones, polyaramides, polyamides, polycarbonates, polyethylenes, polyesters, polyphenols and polyurethanes.

In another embodiment, the composition further comprises one or more types of process aids, modifiers, colorants, fibers, adhesion promoters and fillers.

In still another embodiment, the ceramic powders or particles are selected from the group consisting of alumina, boron carbide, boron nitride, mullite, silica, silicon carbide, silicon nitride, magnesium boride, multi-walled carbon nanotubes, single walled carbon nanotubes, group IVB, VB and VIB metal sulfide nanotubes, titanium boride, titanium carbide, and diamond.

In yet another embodiment, the ceramic powders or particles provide 10% to 98% of the total mass, in a preferred embodiment the ceramic powders or particles provide 20% to 95% of the total mass, and in a most preferred embodiment the ceramic powders or particles provide at least 50% of the total mass.

In still yet another embodiment, the ceramic powders or particles have particle size in the range of 10 nanometers to 100 microns; and in a preferred embodiment the ceramic powders or particles have particle size in the range of 100 nanometers to 10 microns.

In still yet another embodiment, the polymeric material or materials provide 2% to 90% of the total mass, and in a preferred embodiment the polymeric material or materials provide less than 50% of the total mass.

In still yet another embodiment, the polymeric material or materials are thermoplastics.

In still yet another embodiment, the polymeric material is a thermosetting resin.

In still yet another embodiment, the polymer matrix has a tensile modulus of at least 400,000 psi, preferably above at least 600,000 psi, even more preferably above at least 800,000 psi, and even more preferably above at least 1,000,000 psi, and most preferably above at least 1,100,000 psi.

In still yet another embodiment, the polymeric material comprises a polyarylene having a rigid-rod or semi-rigid-rod structure where at least 25% of the repeat units are rigid-rod repeat units with substantially parallel bonds.

In still yet another embodiment, the polymeric material is a polyphenylene resin sold under a trade name PrimoSpire® and available from Solvay Advanced Polymers, LLC. In still yet another embodiment, the ballistic protection materials are fabricated into articles selected from the group consisting of sheets, slabs, disks, and complex shapes.

In still yet another embodiment, the ballistic protection materials are used together with other ballistic materials, including, but not limited to woven ballistic fabrics (such as but not limited to polyaramid or polyethylene fabrics), metals, ceramics, and the like.

In still yet another embodiment, the ballistic protection materials are incorporated into an article selected from the group consisting of: a ballistic protection article, a helmet, a sheet or panel, such as a vehicle or blast protection panel, body armor, and cargo containers.

### BRIEF DESCRIPTION OF THE FIGURES

The above embodiments will be explained in conjunction with the detailed description and exemplary embodiments set forth below by reference to the enclosed figures, which include:

FIG. 1, which provides a schematic diagram of an exemplary joint for interconnecting two pieces of ballistic protection material; and

FIG. 2, which provides a schematic diagram of a second exemplary joint for interconnecting two pieces of ballistic protection material.

### DETAILED DESCRIPTION

The current invention is directed to a ballistic protection material made from a novel polymer/ceramic composite that incorporates a high modulus resin. In contravention of the conventional wisdom, it has been found that using these high modulus resins allows for the production of effective ballistic protection and blast containment materials using low cost molding techniques.

As previously discussed, polymers are typically soft, flexible materials relative to metals, ceramics, glasses, and even wood. Common plastics have elastic moduli (a measure of stiffness) between about 200,000 and 350,000 psi, whereas the elastic modulus of aluminum is 10,000,000 psi and steel is typically 30,000,000 psi.

The reason these low modulus polymers have found widespread use in the field of ballistic protection, and the reason conventional wisdom has led away from higher modulus polymers is two-fold:

First, because of their inherent low glass transition temperatures, low modulus polymers are generally lower in cost to process. Additionally, the base materials for the low modulus polymers tend to be mass produced thermoplastic (aliphatic species such as ethylene, propylene) or thermosetting in nature (epoxies, vinyl esters, acrylates, etc.) species. All of these polymeric species are utilized commercially in very large quantities and consequently are readily available and processable. Owing to their widespread usage, it is incumbent upon these polymers to be easily fabricable, compoundable and moldable. Accordingly, as a result of both inherent low glass transition temperatures and the market pressures, Low modulus polymers have very good processability/cost profiles. In contrast, high modulus polymers are, in general, manufactured for niche applications. As such, they are tightly focused on the demands of that particular application, and this is chiefly (although not exclusively) high temperature resistance. Since these materials are more tightly focused from the marketing perspective, their availability, both from the cost and processing options is much more limited than the traditional, wide market low modulus polymers.

Coupled with this market pressure is the conventional belief that high modulus polymeric materials would be less suitable for use in ballistic protection applications. This second pressure to use low modulus polymers in these applications is principally based on a flawed, but widely held view, that the ductility profile of low modulus polymers is better suited for use in conjunction with ceramics. Specifically, from a material science perspective, ceramic materials possess a number of very attractive features. They have high stiffness and hardness, high usage temperatures and excellent resistance to oxidation and variety of chemical agents experienced in everyday usage. They do, however, suffer from a very serious drawback of limited ductility. In general, all ceramic materials suffer from brittleness and this severely limits their ultimate strengths and thus their applicability in mechanically demanding applications. In contrast, low modulus polymers, in general, tend to have the opposite set of material properties. They have very low stiffness and hardness values but they do, in comparison to ceramic materials, have excellent ductility properties. As a result, traditionally, low modulus polymers were used in conjunction with ceramics in an attempt to mitigate some of their brittleness issues, the ultimate goal being to create a composite that would combine the very high hardness of ceramics with the improved ductility of the low modulus polymeric materials, thereby possessing the best properties of both material classes.

Naturally, high modulus polymers were not utilized in these systems. The conventional viewpoint was that the hardness of these materials, although somewhat higher than the low modulus polymers, was still multiple orders of magnitude lower than ceramics (and thus would not be expected to elevate the overall hardness of the composite significantly), while these high modulus polymers tend to have significantly lower ductility attributes. Thus, under conventional practices there appeared to be no reason to trade off the ductility of the low modulus polymers, for the small gains obtained in the overall hardness and stiffness of the composite.

However, a novel class of polymers known as rigid-rod polymers can have moduli above 1,000,000 psi, and are three to four times stiffer than conventional plastics. Despite this comparatively low hardness and stiffness (in comparison to ceramics), it has been surprisingly found that ballistic protection devices fabricated from high modulus polymer (including rigid-rod polymers) composites with ceramic powders, have higher performance than those fabricated from intermediate and low modulus polymers, and can form ballistic protection materials having a high tensile modulus. While not wishing to be bound by theory, it is believed that the high modulus polymer matrix/hard ceramic composites are more capable of deforming incoming projectiles than the soft polymer matrix/hard ceramic composites. It is also thought that the hydrodynamically deforming region around a projectile during impact is held more tightly in place by a polymer of high compressive stiffness. This causes greater deformation to the projectile and therefore greater ballistic protection.

Accordingly, in one embodiment of the present invention the matrix polymers include high modulus thermoplastics chosen for the ability to incorporate (be compatible with), or be able to be mixed with, the hard ceramics and other additives, and which are processable via melt-processing methods, including but not limited to compression molding, extrusion, injection molding, coining, blow molding, thermoforming, and the like.

Although any suitable combination of polymer and ceramic may be used, in one embodiment the ceramic powders or particles provide 10% to 98% of the total mass, in a preferred embodiment the ceramic powders or particles provide 20% to 95% of the total mass, and in a most preferred embodiment the ceramic powders or particles provide at least 50% of the total mass. Likewise, the polymeric material or materials provide 2% to 90% of the total mass, and in a preferred embodiment the polymeric material or materials provide less than 50% of the total mass.

Similarly, although any suitable size and shape of ceramic particle may be used with the ballistic protection materials of the current invention, in one embodiment, the ceramic powders or particles have particle size in the range 10 nanometer to 100 micron, and in a preferred embodiment the ceramic powders or particles have particle size in the range 100 nanometer to 10 micron.

In a preferred embodiment, thermoplastic polymers useful in the current invention include but are not limited to materials that exhibit a high elastic modulus. Most preferably, thermoplastic polymers include rigid-rod polyphenylene materials known as PrimoSpire™ materials (Solvay Advanced Polymers, L.L.C.). PrimoSpire™ polymers may be blended with other polymers such as polysulfones and polycarbonates. Thermoplastic polymers useful in the practice of the present invention also include but are not limited to polysulfones, polyaramids, polyamides, polyimides, polyetherimides, polyimideamides, polyaryletherketones, polyetherketones, liquid crystal polymers, polybenzbisoxazoles, polybenzbisthiazoles, polybenzbisimidazoles, polycarbonates, polyethylenes, polyesters, and the like.

Rigid-rod polymers and semi-rigid-rod polymers suitable for use with the present invention are disclosed in U.S. Pat. Nos. 5,227,457; 5,646,231; 5,646,232; 5,654,392; 5,659,005; 5,721,335; 5,731,400; 5,756,581; 5,760,131; 5,789,521; 5,886,130; 5,976,437; and 6,087467 all of which are incorporated herein by reference.

In another embodiment of the present invention the matrix polymers include thermosetting materials chosen for the ability to incorporate (be compatible with), or be able to be mixed with, the specific ceramics and other additives, and which are processable via thermosetting molding methods.

Thermosetting polymers useful for the present invention include but are not limited to materials that exhibit a high elastic modulus. Thermosetting polymers include but are not limited to polyphenols, polyesters, polyurethanes, bismaleimide resins, bis-benzocyclobutene resins, phthalonitrile resins epoxies, and the like. Thermosetting resins based on thermoplastics or oligomers having acetylene or substituted acetylene end groups are also useful as matrix resins for the instant invention. Examples of acetylene endcapped resins include but are not limited to PETI-5, and Thermid® resins (National Starch and Chemical Co., Bridgewater, N.J. 08807). Use of PETI-5 in composites is disclosed in U.S. Pat. No. 6,441,099 incorporated in full by reference.

Thermosetting rigid-rod polymers useful as the matrix resin in the present invention are disclosed in a series of patents entitled “Macromonomers Having Reactive End Groups,” (U.S. Pat. Nos. 5,827,927; 5,824,744; and 5,670,564), which are incorporated herein by reference. Additional thermosetting rigid-rod polymers useful as the matrix resin in the present invention are disclosed in a series of patents entitled “Macromonomers Having Reactive Side Groups,” (U.S. Pat. Nos. 5,869,592; 5,830,945; 5,625,010; 5,539,048; 5,512,630; and 5496,893), which are incorporated herein by reference.

The polymer matrices of the present invention also may also include materials that can be melt processed or otherwise molded and then subsequently further processed to modify properties, e.g., materials that are injection molded then cured at high temperatures to effect a degree of cross linking or further chemical reaction, including but not limited to polyamideimides.

Regardless of the specific polymer or polymers used to make the polymer matrix it is preferred that the polymer matrix have a tensile modulus of at least 400,000 psi, preferably above at least 600,000 psi, even more preferably above at least 800,000 psi, and even more preferably above at least 1,000,000 psi, and most preferably above at least 1,100,000 psi. One reasonably skilled in the art will know how to select particular members of these polymer classes at the high end of the modulus range for each series. Polymer manufactures typically provide specification sheets with each grade of polymer listing elastic modulus as well as other properties such at glass transition temperature, melting temperature, and melt viscosity to aid customers select and process the materials. Manufactures will often recommend coupling agents, and processing aid to be used with their polymers and inorganic fillers.

Process aids and modifiers are materials commonly used to facilitate polymer fabrication, to help compatibilize the mixture of polymers, ceramics, and other additives, and the like, to increase fire resistance, or to modify other properties, other than primary ballistic protection properties. Any of these material that are desirable for fabricating or using the new lightweight ballistic protection materials may be incorporated into the current invention, including but not limited to materials such as silicones, phthalates, bromides, and the like.

Other additives, present in amounts not exceeding 10% by weight, if any, may also be included. These materials may include, but are not limited to adhesion aides, colorants, fibers (carbon, polyaramid, polyethylene, etc.), fillers (talc, sand, microballoons) that further serve to modify the processability, stability, durability, or appearance of the objective ballistic protection materials.

Any suitable ceramic materials may be used in the composite composition in accordance with the current invention. In one embodiment the ceramic powders or particles may be selected from the group consisting of alumina, boron carbide, boron nitride, mullite, silica, silicon carbide, silicon nitride, magnesium boride, multi-walled carbon nanotubes, single walled carbon nanotubes, group IVB, VB and VIB metal sulfide nanotubes, titanium boride, titanium carbide, and diamond.

The current invention is also directed to methods of preparing ballistic protection materials. In one embodiment, the ballistic protection material is formed by a simple process of mixing the starting materials without melt processing prior to the final molding step. This simplifies the processing, as it is not necessary to undertake the possibly complicated step of melt processing with its accompanying difficulties in dispersion and equipment wear.

Although such a simple mixing process may be used, other processes for forming the ballistic protection material of the current invention can also be utilized. These include melt compounding, in which the ceramic and the polymer are intimately mixed while the polymer is in the molten state. In this embodiment the mixing can be done in any suitable standard machinery such as single and twin-screw extruders (both co- and counter-rotating), Henschel mixers, co-kneaders, etc. An additional technique that can be used is solvent mixing in which the ceramic and the polymer are mixed while the polymer is dissolved in the appropriate solvent. In such an embodiment any suitable solvent may be utilized.

The current invention is also directed to articles made with the ballistic protection material in accordance with the above processes. Ballistic protection materials of the present invention may be fabricated into any suitable article, including but not limited to sheets, slabs, disks, or more complex shapes, of varying thicknesses and sizes.

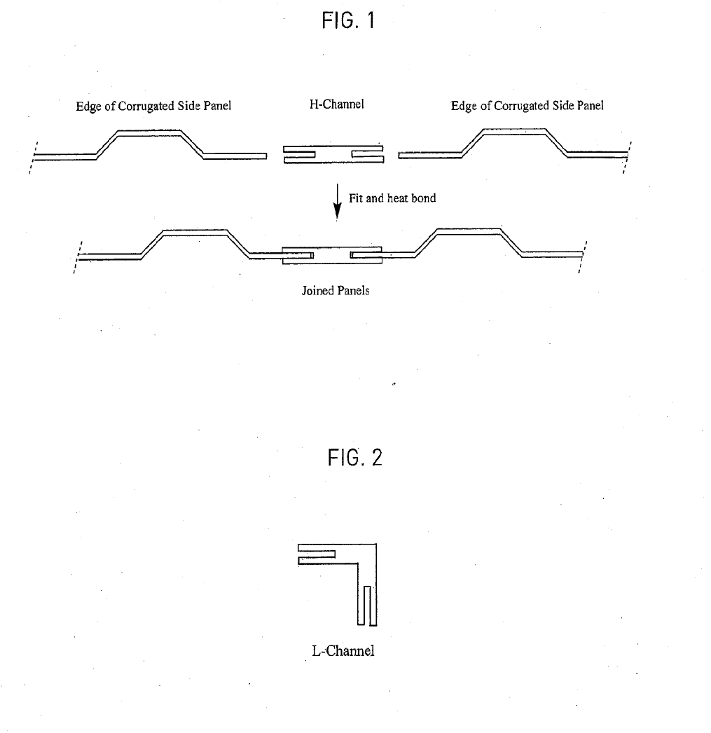

In one exemplary embodiment, as shown in FIGS. 1 and 2, the materials are formed into sheets that can be interconnected through a series of novel locking channels. For example, as shown in FIGS. 1 and 2, in one embodiment, the material may be formed into an H-Channel useful for coupling two panels and an L-Channel for edge coupling. In such an embodiment, the channel and corner pieces may be fitted with heating elements to allow quick construction of vehicle protection panels. Alternatively, channel and corner pieces and corrugated panels may be welded using ultrasonic, laser, or heated iron means. Yet another alternative construction is to rivet, bolt, or glue the various pieces to form the structure.

Using such construction techniques, the ballistic protection materials of the present invention may be used together with other ballistic materials, including but not limited to woven ballistic fabrics (such as but not limited to polyaramid or polyethylene fabrics), metals, ceramics, and the like to form ballistic protection articles, such as, for example, helmets, sheets or panels, or body armor. In another example, body armor using the inventive material may be fabricated by first forming a woven fiber vest containing pockets then sewing flat or curved panels or tiles comprising the composite into the pockets. The sheets or panels may also be incorporated into a number of blast or ballistic shields or armor, such as, for example, blast/ballistics shields or armor for vehicles, aircraft and watercraft like cars, trucks, vans, personnel carriers, limousines, trailers, helicopters, cargo planes, rail cars, boats and ships; armor or blast/ballistic protection for small buildings, especially military command posts and mobile headquarters; armor or blast/ballistic protection for cargo containers; armor or blast/ballistic protection for equipment housing, such as, for example, computers, communications equipment; and generally mobile or stationary blast or ballistic protection panels.

### EXEMPLARY EMBODIMENTS

The following exemplary embodiments are provided to show possible ballistic protection composition formulations, methods of forming such compositions, and articles made by such compositions, and should not be taken as a definitive listing of all possible ballistic protection compositions in accordance with the current invention.

### Example 1

PrimoSpire™ 120 (Solvay Advanced Polymers, L.L.C.) 5 kg and Radel R (Solvay Advanced Polymers, L.L.C.) 5 kg are melt blended in a mixing extruder, and extruded as micropellets approximately 1 mm dia by 1 mm long (Blend A pellets). To 900 g alumina powder is added aminopropyltriethoxysilane 5 g and 95 g of Blend A pellets and mixed in a tumble mixer. Following the initial mixing in the tumble mixer, the resulting mixture of powder and pellets is placed in a Henschel-type high intensity mixer and melt compounded. The resulting melt is placed in a circular compression mold at 350° C. and compression molded at 3000 psi for 1 hour. The resulting disc is suitable for use as a ballistic protection material.

### Example 2

PrimoSpire™ 120 (Solvay Advanced Polymers, L.L.C.) 500 g, Radel R (Solvay Advanced Polymers, L.L.C.) 450 g, and 50 l NMP are heated to 80° C. with stirring until the polymers are dissolved, then cooled to room temperature. To this solution is added alumina powder 9 kg and aminopropyltriethoxysilane 50 g. This mixture is stirred vigorously to suspend the solids and slowly poured into 100 l anhydrous ethanol. The solids are collected by centrifugal filtration, washed with 50 l anhydrous ethanol, and the wet cake dried in a tumble dryer at 50° C. The dry solids are then compression molded at 350° C. and 1,000 psi into tiles suitable for use in personal ballistic protection vest.

### Example 3

Composite panels of Example 1 or 2 are used in conjunction with the bullet resistant ballistic panel carrier garment disclosed in U.S. Pat. No. 4,266,297 (Atkins, J. H.), the disclosure of which is incorporated herein by reference.

### Example 4

PrimoSpire™ 250 (Solvay Advanced Polymers, L.L.C.) 10 kg is compounded in single screw extruder (NPM, 1 1/2 in, 24:1) and extruded as pellets approximately 3 mm dia by 1 mm long. To 900 g alumina powder is added aminopropyltriethoxysilane 5 g and 95 g of PrimoSpire™ 250 pellets and mixed in a tumble mixer. Following the initial mixing in the tumble mixer, the resulting mixture of powder and pellets is placed in a Henschel-type high intensity mixer and melt compounded. The resulting melt is placed in a circular compression mold at 350° C. and compression molded @ 3000 psi for 1 hour. The resulting disc is suitable for use as a ballistic protection material.

### Example 5

PrimoSpire™ 250 (Solvay Advanced Polymers, L.L.C.) 1000 g and 50 l NMP are heated to 80° C. with stirring until the polymers are dissolved, then cooled to room temperature. To this solution is added alumina powder 9 kg and aminopropyltriethoxysilane 50 g. This mixture is stirred vigorously to suspend the solids and slowly poured into 100 l anhydrous ethanol. The solids are collected by centrifugal filtration, washed with 50 l anhydrous ethanol, and the wet cake dried in a tumble dryer at 50° C. The dry solids are compression molded at 350° C. and 1,000 psi into tiles suitable for use as ballistic protection materials.

### Example 6

PrimoSpire™ 250 (Solvay Advanced Polymers, L.L.C.) 1 kg powder with a mean particle size of 60 μm is mixed with 9 kg silicon carbide powder with mean particle size of 63 μm. The resulting powder is placed directly into the compression mold and molded using the method of Example 1.

### Example 7

PrimoSpire™ 120 (Solvay Advanced Polymers, L.L.C.) 1 kg powder with a mean particle size of 80 μm is mixed with 9 kg boron carbide powder (−325 mesh). The resulting powder is placed directly into the compression mold and molded using the method of Example 1.

### Example 8

Tiles obtained using the process of Example 7, are placed on a heated plate at 220° C. until the thermal equilibrium is reached. The hot tiles are bent around a steel pipe with the approximate diameter of 12 in and subsequently cooled. The resulting tiles have the curvature corresponding to the curvature of the pipe and are useful for protecting curved objects from ballistic impact.

### Example 9

PrimoSpire™ 250 (Solvay Advanced Polymers, L.L.C.) 50 kg, Radel R 5000 (Solvay Advanced Polymers, L.L.C.) 250 kg, alumina 400 kg, and aminopropyltrimethoxysilane 2 kg (Mixture A) are melt blended in a mixing extruder, and extruded as a sheet and a channel as shown in FIGS. 1 and 2 for the fabrication of cargo containers. For example, a corrugated sheet 1.2 m wide by 7 mm thick by 2.6 m long useful for protective panels of commercial and military vehicles may be manufactured using this process.

While the above description contains many specific embodiments of the invention, these should not be construed as limitations on the scope of the invention, but rather as an example of one embodiment thereof. Many other variations are possible. Accordingly, the scope of the invention should be determined not by the embodiments illustrated, but by the appended claims and their equivalents.

What is claimed is:

1. A composite material comprising:
a polymer matrix having a tensile modulus of at least 400,000 psi; and
a ceramic material, wherein the ceramic material is between 10% and 98% of the composite material by weight.

2. The composite material of claim 1, wherein the ceramic material is between 20% and 95% of the composite material by weight.

3. The composite material of claim 1, wherein the ceramic material is at least 50% of the composite material by weight.

4. The composite material of claim 1, wherein the ceramic material is formed of a plurality of particles having particle sizes in the range of from 10 nanometers to 100 microns.

5. The composite material of claim 1, wherein the ceramic material is formed of a plurality of particles having particle sizes in the range of from 100 nanometers to 10 microns.

6. The composite material of claim 1, wherein the polymer matrix is less than 50% of the composite material by weight.

7. The composite material of claim 1, wherein the polymer matrix comprises one or more of the polymer materials selected from the group consisting of rigid-rod polymers, polyimides, polyetherimides, polyimideamides, polysulfones, epoxy resins, bismaleimide resins, bis-benzocyclobutene resins, phthalonitrile resins, polyaryletherketones, polyetherketones, liquid crystal polymers, oligomeric cyclic polyester precursors, polybenzbisoxazoles, polybenzbisthiazoles, polybenzbisimidazoles, acetylene endcapped thermosetting resins, PrimoSpire™ polymers, polysulfones, polyaramides, polyamides, polycarbonates, polyethylenes, polyesters, polyphenols and polyurethanes.

8. The composite material of claim 1, wherein the polymer matrix is formed at least partially of a thermosetting resin.

9. The composite material of claim 1, wherein the polymer matrix is formed at least partially of a thermoplastic.

10. The composite material of claim 1, wherein the polymer matrix is formed at least partially of a polyarylene having one of either a rigid-rod or semi-rigid-rod structure where the structure is formed of a plurality of repeat units where 25% of the repeat units are rigid-rod repeat units having substantially parallel bonds.

11. The composite material of claim 1, wherein the polymer matrix is formed of at least a polyphenylene polymer.

12. The composite material of claim 11, wherein the polyphenylene polymer is selected from the group of PrimoSpire® resins.

13. The composite material of claim 11, wherein the polymer matrix further comprises at least one other polymer independently selected from the group consisting of polyimides, polyetherimides, polyimideamides, polysulfones, epoxy resins, bismaleimide resins, bis-benzocyclobutene resins, phthalonitrile resins, polyaryletherketones, polyetherketones, liquid crystal polymers, oligomeric cyclic polyester precursors, polybenzbisoxazoles, polybenzbisthiazoles, polybenzbisimidazoles, acetylene endcapped thermosetting resins, PrimoSpire™ polymers, polysulfones, polyaramides, polyamides, polycarbonates, polyethylenes, and polyesters.

14. The composite material of claim 1 wherein the polymer matrix has tensile modulus of at least 1,000,000 psi.

15. The composite material of claim 1, wherein the ceramic material comprises one or more of the ceramic powders or particles selected from the group consisting of alumina, boron carbide, boron nitride, mullite, silica, silicon carbide, silicon nitride, magnesium boride, multi-walled carbon nanotubes, single walled carbon nanotubes, group IVB metal sulfide nanotubes, group VB metal sulfide nanotubes, group VIB metal sulfide nanotubes, titanium boride, titanium carbide and diamond.

16. The composite material of claim 1, further comprising at least one additive material selected from the group consisting of process aids, modifiers, colorants, fibers, adhesion promoters and fillers.

17. The composite material of claim 16, wherein the adhesion promoter is aminopropyltriethoxysilane.

18. A ballistic protection article formed using a composition comprising:
a polymer matrix having a tensile modulus of at least 400,000 psi; and
a ceramic material, wherein the ceramic material is between 10% and 98% of the composite material by weight.

19. The ballistic protection article of claim 18, wherein the polymer matrix is formed of a polyphenylene polymer and at least one other polymer independently selected from the group consisting of polyimides, polyetherimides, polyimideamides, polysulfones, epoxy resins, bismaleimide resins, bis-benzocyclobutene resins, phthalonitrile resins, polyaryletherketones, polyetherketones, liquid crystal polymers, oligomeric cyclic polyester precursors, polybenzbisoxazoles, polybenzbisthiazoles, polybenzbisimidazoles, acetylene endcapped thermosetting resins, PrimoSpire™ polymers, polysulfones, polyaramides, polyamides, polycarbonates, polyethylenes, and polyesters.

20. The ballistic protection article of claim 18, wherein the article takes a shape selected from the group consisting of a sheet, slab, disk, L-channel, H-channel and curved tiles.

21. The ballistic protection article of claim 18, wherein the article is an item selected from the group consisting of helmets, body armor, vehicle armor, aircraft armor, watercraft armor, structure armor, equipment housing, blast protection panels, ballistic protection panels and cargo containers.

22. A process for forming a ballistic protection article comprising:
mixing at least one polymer material and at least one ceramic material to form a composite material having a polymer matrix and a ceramic material, where the resulting polymer matrix has a tensile modulus of at least 400,000 psi and where the ceramic material is between 10% and 98% of the composite material by weight; and
shaping the composite material into an article.

23. The process of claim 22, wherein the step of shaping comprises using a technique selected from the group consisting of molding, compression molding, stamping, bending, thermoforming, injection molding, coining and extruding.

24. The process of claim 22, wherein the polymer material and the ceramic material are mixed using a machine selected from the group consisting of a single screw extruder, a counter-rotating twin-screw extruder, a co-rotating twin-screw extruder, a Henschel mixer, and a co-kneader.

25. The process of claim 22, wherein the polymer material is dissolved in a solvent to form a mixture prior to combining with the ceramic material, and then further comprising removing the solvent to form a conglomerate of composite material prior to molding.

26. The process of claim 25, wherein the step of removing the solvent includes adding the mixture of solvent, polymer material and ceramic material to a non-solvent followed by filtering the mixture to form the conglomerate of the composite material.

27. The process of claim 25 wherein the step of removing the solvent includes evaporating the solvent from the composite material to form the conglomerate.

28. The process of claim 22 further comprising adding at least one additive material selected from the group consisting of process aids, modifiers, colorants, fibers, adhesion promoters and fillers prior to combining.

29. A process for forming a ballistic protection article comprising
extruding at least one polymer material as a plurality of micropellets;
mixing the micropellets with a ceramic material to form a mixture;
compounding the mixture of micropellets and ceramic material in a Henschel mixer to form a compounded mixture; and
shaping the compounded mixture into an article.

30. The process of claim 29, wherein the micropellets and the ceramic material are mixed using a machine selected from the group consisting of a single screw extruder, a counter-rotating twin-screw extruder, a co-rotating twin-screw extruder, a Henschel mixer, and a co-kneader.

31. The process of claim 29, wherein the polymer material is a mixture of at least two different polymers, and further comprising melt blending the polymers in a mixing extruder to form a mixed polymer material prior to extruding.

32. The process of claim 31, wherein the at least two different polymers are a thermoplastic and one of either a rigid-rod or a semi-rigid-rod polymer.

33. The process of claim 29, wherein the step of shaping comprises using a technique selected from the group consisting of molding, compression molding, stamping, bending, thermoforming, injection molding, coining and extruding.

34. The process of claim 29, further comprising adding at least one additive material selected from the group consisting of process aids, modifiers, colorants, fibers, adhesion promoters and fillers prior to compounding.

35. The process of claim 29, further comprising thermoforming the molded article on one of either a mold or a die.
